(19) United States
(12) Patent Application Publication
(10) Pub. No.: US 2018/0209564 A1
(43) Pub. Date: Jul. 26, 2018

(54) PLIABLE ADHESIVE FLASHING SHEET

(71) Applicant: WJG, LLC, Las Vegas, NV (US)

(72) Inventors: William J. Gilleran, Las Vegas, NV (US); Craig Ratajczyk, Las Vegas, NV (US)

(21) Appl. No.: 15/824,890

(22) Filed: Nov. 28, 2017

Related U.S. Application Data
(60) Provisional application No. 62/450,402, filed on Jan. 25, 2017.

(51) Int. Cl. F16L 5/10; E04D 13/147

(52) U.S. Cl. CPC F16L 5/10; E03B 7/09; E04D 13/1476

(57) ABSTRACT

A flashing sheet includes a pliable sheet having a first surface, an opposing second surface, and a first opening extending through the pliable sheet between the first surface and the second surface. The flashing sheet further comprises a resilient seal element including a first surface, an opposing second surface, and a second opening extending through the resilient seal element between the first surface and the second surface. The resilient seal element is coupled to the pliable sheet such that the second opening is aligned with the first opening, and at least a portion of the resilient seal element extends radially inward to extend over the first opening.

### CROSS-REFERENCE TO RELATED APPLICATIONS

This application claims the benefit of U.S. Provisional Application No. 62/450,402, filed Jan. 25, 2017, the content of which is expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to a flashing sheet, and more specifically to a pliable flashing sheet having an adhesive layer and a central elastomeric sealing element adapted to form a fluid tight seal about a utility conduit or an electrical box.

### 2. Description of the Related Art

In the construction of houses, commercial buildings, and the like, various utility/plumbing conduits such as water pipes, gas pipes, drain pipes, as well as electrical boxes etc., extend through the walls of the building and terminate outside the building so as to be accessible by a user. When exteriorly terminated, these pipes extend through insulation, between wall boards, potentially within ceiling and floor structures, and in other critical places where a dry environment is extremely important for both structural and safety considerations. The exteriorly exposed pipe ends are periodically subjected to water sources, whether from rain, snow, lawn sprinklers, vandalism, or other sources. Such water has a natural tendency to travel on the exterior of the pipe for attempted entry into the building structure. If such water enters through the exterior building wall, it can cause substantial damage to insulation, dry wall, wood moldings, flooring, and carpeting on the interior of the building.

The importance of attempting to mitigate water entry through such pipe terminations has been recognized by the building industry with various attempts being recently made to prevent such intrusive water travel. One presently employed approach utilizes caulking material applied at the interface of the pipe with lathing paper disposed immediately behind the pipe outlet. Thereafter, stucco or other exterior finishing material may be applied over the lathing paper to be adjacent to the exposed pipe length while allowing the pipe end to be exteriorly accessible. Over time, however, such caulking can eventually crack and break, and when this occurs, water can freely travel along the pipe surface and into the interior of the building structure.

A second common approach is individually performed at every pipe outlet at a job site and entails hand measuring and cutting of sheet metal to create flashing thereafter fitted around the pipe behind the pipe opening and nailed in place and caulked. Once again, although this approach can work initially, the caulking material eventually gives way or is not initially caulked properly, which allows water to travel over the pipe surface and into the structure. In this latter situation, and depending upon pipe material and flashing material such as copper and sheet metal respectively, electrolysis can occur as an interaction of the pipe material, e.g., copper, and the flashing metal, e.g., sheet metal.

Accordingly, there is a need in the art for a more user friendly and durable flashing products for use with utility conduits and/or electrical boxes to mitigate unwanted passage of moisture into a building. Various aspects of the present disclosure address this particular need, as will be discussed in more detail below.

### BRIEF SUMMARY

In accordance with one embodiment of the present disclosure, there is provided a flashing sheet comprising a pliable sheet having a first surface, an opposing second surface, and a first opening extending through the pliable sheet between the first surface and the second surface. The flashing sheet further comprises a resilient seal element including a first surface, an opposing second surface, and a second opening extending through the resilient seal element between the first surface and the second surface. The resilient seal element is coupled to the pliable sheet such that the second opening is aligned with the first opening, and at least a portion of the resilient seal element extends radially inward to extend over the first opening.

The pliable sheet may be fluid impermeable. The pliable sheet may be a membrane sheet. The pliable sheet may be formed from an elastomeric material. The pliable sheet may be formed from flexible polyvinyl chloride. The pliable sheet may be formed from polyethylene.

The pliable sheet may include a base layer having an adhesive coating. The flashing sheet may additionally include a release liner extending over the base layer to cover the adhesive coating, with the release liner being selectively removeable to expose the adhesive coating.

The pliable sheet may lack internal stiffness to counteract gravitational force.

The resilient seal element may be adhered to the pliable sheet. The resilient seal element may be formed from a polymer material.

The second opening of the resilient seal element may be circular. The second opening of the resilient seal element may be quadrangular. The second opening of the resilient seal element may be approximately 4.875 inches by 2.750 inches.

According to another embodiment a flashing sheet includes a sheet having a first surface, an opposing second surface, and a first opening extending through the sheet between the first surface and the second surface. The sheet includes a base layer having an adhesive coating, and a release liner extending over the adhesive coating to cover the adhesive coating. The release liner is selectively removeable from the adhesive coating to expose the adhesive coating. The flashing sheet additionally includes a resilient seal element having a first surface, an opposing second surface, and a second opening extending through the resilient seal element between the first surface and the second surface. The resilient seal element is coupled to the sheet such that the second opening is aligned with the first opening, and at least a portion of the resilient seal element extends radially inward to extend over the first opening.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a perspective view of a first embodiment of a pliable, self-adhering flashing sheet;

FIG. 2 is a cross-sectional view of the flashing sheet depicted in FIG. 1;

FIG. 3 is a partially exploded view of the flashing sheet with a portion of a removable layer removed from a base layer to expose an adhesive coating;

FIG. 4 is a perspective view of the flashing sheet depicted in FIG. 1 aligned with a utility conduit extending through a shear panel covered with weather-proofing sheets;

FIG. 5 is a perspective view of the flashing sheet disposed about the utility conduit and adhered to the weather-proofing sheets;

FIG. 6 is a plan view of an embodiment of a pliable flashing sheet having a central elastomeric sealing member adapted to form a circumferential seal around an electrical box; and

FIG. 7 is a perspective view of the flashing sheet of FIG. 6 coupled to weather-proofing sheets disposed about the electrical box, with the electrical box extending through the flashing sheet.

Common reference numerals are used throughout the drawings and the detailed description to indicate the same elements.

### DETAILED DESCRIPTION

The detailed description set forth below in connection with the appended drawings is intended as a description of certain embodiments of a flashing sheet and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

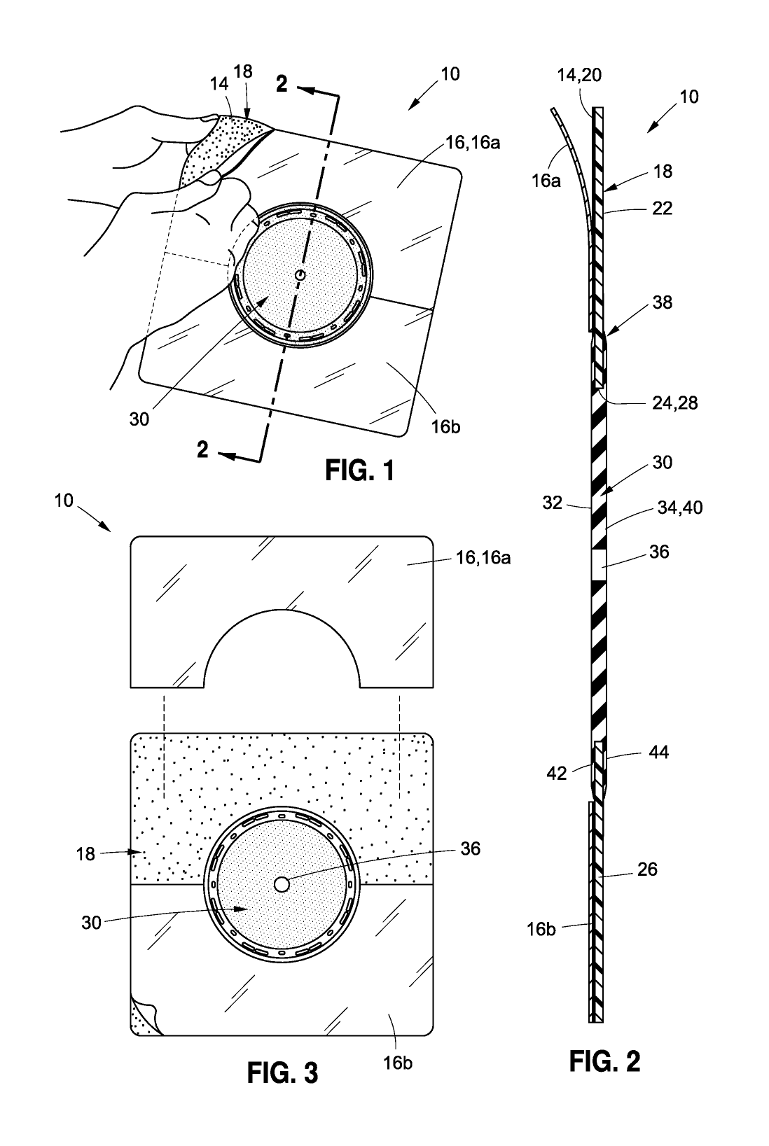

Referring now to FIGS. 1-5, wherein the showings are for purposes of illustrating a preferred embodiment of the present disclosure, and are not for purposes of limiting the same, there is depicted a pliable, self-adhering flashing sheet 10 for use in providing a water-tight seal around a utility conduit 12 extending through a wall of a building. As will be described in more detail below, the flashing sheet 10 includes an adhesive coating or layer 14 that is exposed by removing a release liner 16. In this regard, the flashing sheet 10 is specifically configured and adapted to allow a user to easily “peel and stick” the flashing sheet 10 in place, thereby making the flashing sheet 10 extremely user friendly.

According to one embodiment, the flashing sheet 10 generally includes a pliable sheet 18. As used herein, the term “pliable” refers to the ability of the sheet 18 to bend or flex. Furthermore, with the sheet 18 being pliable, the sheet 18 lacks internal stiffness to counteract gravitational force. Therefore, if the user attemps to hold the sheet 18 in a horizontal plane, the sheet 18 will simply collapse and succum to the gravitational force. In other words, according to one embodiment, the sheet 18 is incapable of being disposed in compression. To be clear, the sheet 18 may be disposed in tension by pulling opposed ends of the sheet 18 in opposite directions. Thus, at least in relation to the pliable nature of the sheet 18, the sheet 18 may be bent or flexed, much like a single sheet of paper.

The pliable sheet 18 includes a first surface 20, an opposing second surface 22, and a first opening 24 extending through the pliable sheet 18 between the first surface 20 and the second surface 22. Referring specifically to FIG. 2, the exemplary embodiment of the pliable sheet 18 includes a base layer 26 and the adhesive layer 14, with the adhesive layer 14 defining the first surface 20 and the base layer 26 defining the second surface 22. The adhesive layer 14 extends over the base layer 26 opposite the second surface 22. It is contemplated that the adhesive “layer” may simply include an adhesive coating, and thus, may not significantly contribute to the overall thickness of the pliable sheet 18. Alternatively, in other embodiments, it is contemplated that the adhesive layer 14 may have a discernable thickness.

As noted above, the flashing sheet 10 additionally includes release liner 16 extending over the adhesive layer 14 to preserve the adhesive until the user is ready to use the flashing sheet 10. The release liner 16 is configured to be removeable or separable from the pliable sheet to expose the adhesive layer 14 to allow a user to adhere the pliable sheet 10 in a desired location. In one embodiment, the release liner 16 is separated into separate portions to facilitate attachment of the flashing sheet 10 to an underlying structure, as will be described in more detail below. In the exemplary embodiment, the release liner 16 includes two portions, namely, a first portion 16a and a second portion 16b. However, it is understood that the release liner 16 may be formed of a single sheet, or more than two portions without departing from the spirit and scope of the present disclosure.

The exemplary pliable sheet 18 is quadrangular in shape, although it is understood that the pliable sheet 18 may define other shapes known by those skilled in the art. Furthermore, the pliable sheet 18 includes an inner edge 28 that defines the first opening 24. In the exemplary embodiment, the first opening 24 is circular in shape, although the first opening 24 may be other shapes.

The pliable sheet 18 is a fluid impermeable, membrane sheet. According to one embodiment the membrane sheet is formed from an elastomeric material. Along these lines, the pliable sheet is very similar to conventional shower pan liners or membranes, as well as self-adhered roofing underlayments design to protect homes from rain and ice. An example of a self-adhered roofing underlayment is the Grace Ice & Water Shield®. One exemplary embodiment of the membrane sheet is a high strength polyethylene flexible film coated on one side with a layer of rubberized asphalt adhesive. It is also contemplated that the membrane sheet may be formed of flexible polyvinyl chloride, although other materials known in the art may also be used.

The pliable sheet may be manufactured in several different thicknesses (i.e., the distance between the opposing first and second surfaces 20, 22), including, but not limited to 30 mil, 40 mil, or other thicknesses known in the art. Furthermore, the dimensions of the pliable sheet may also vary, although one exemplary size for the pliable sheet is 11⅛″×11⅛″.

Attached to the pliable sheet 18 is a resilient seal element 30 adapted to form a fluid-tight seal around the utility conduit 12. The resilient seal element 30 including a first surface 32, an opposing second surface 34, and a second opening 36 extending through the resilient seal element 30 between the first surface 32 and the second surface 34. The resilient seal element 30 is coupled to the pliable sheet 18 such that the second opening 36 is aligned with the first opening 24 formed in the pliable sheet.

In the exemplary embodiment, the resilient seal element 30 includes an annular attachment element 38 peripherally located relative to a central body portion 40, with the annular attachment element 38 being specifically configured to facilitate connection between the resilient seal element 30 and the pliable sheet 18. The resilient seal element 30 includes a first flange 42 and an opposing second flange 44 forming annular channel therebetween. A radially inward portion of the pliable sheet 18, including the inner edge 28, is received within the annular channel to connect the resilient seal element 30 to the pliable sheet 18. The resilient seal element 30 may be connected to the pliable sheet 18 via an adhesive, ultrasonic welding, or through the use of other fastening means or techniques known by those skilled in the art. When the resilient seal element 30 is attached to the pliable sheet 18, at least a portion of the resilient seal element 30 extends radially inward from the inner edge 28 of the pliable sheet 18 and over the first opening 24.

It is also contemplated that the resilient seal element 30 may be adhered to the pliable sheet 18 via the adhesive coating 14 on the pliable sheet 18.

The resilient seal element 30 may be formed from a material that allows the utility conduit 12 to pass through the second opening 36, with the resilient seal element 30 forming a fluid-tight seal around the utility conduit 12. In particular, the resilient seal element 30 circumferentially engages with the conduit 12 and applies a compressive force against the conduit 12 to form the seal. According to one embodiment, the resilient seal element 30 is formed from an elastomeric material, although rubbers and other materials known in the art may also be used.

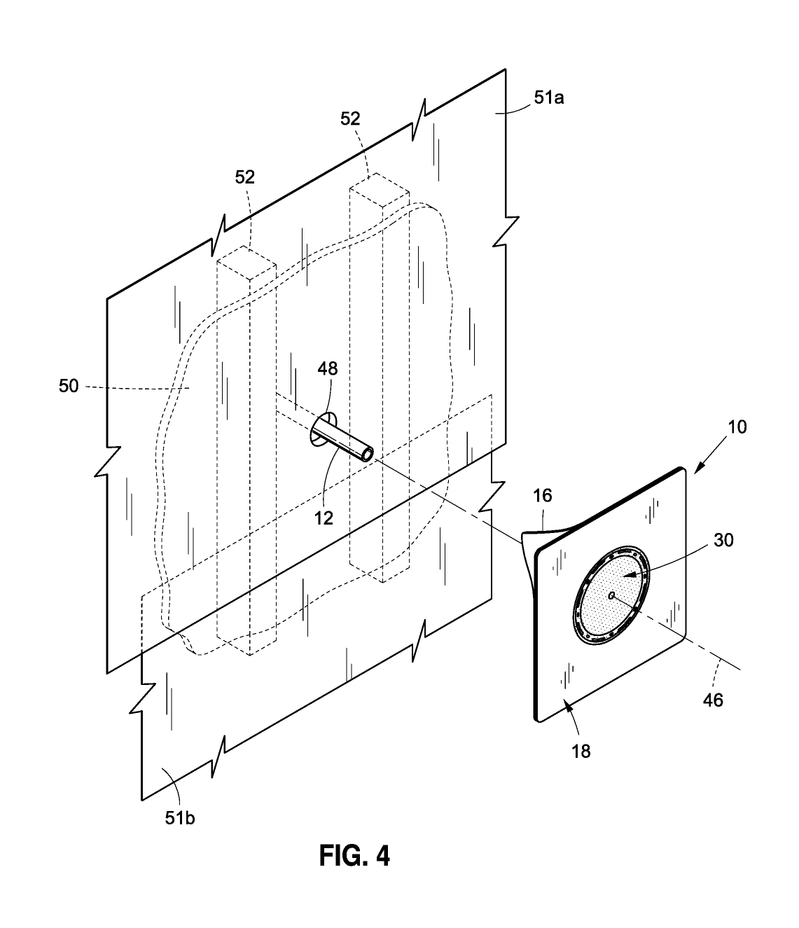

With the basic structure of the flashing sheet 10 described above, the following discussion will focus on an exemplary use of the flashing sheet 10. As noted above, the flashing sheet 10 is used to create a fluid tight seal around a utility conduit 12 and to prohibit moisture from entering the building along the external surface of the utility conduit 12. FIG. 4 shows utility conduit 12, shear panel 50, weatherproofing sheets 51a, 51b, and studs 52. The shear panel 50 and weatherproofing sheet 51a include an opening 48 formed therein, with the utility conduit 12 extending through the opening 48. An exemplary weatherproofing sheet is Tyvek™ HomeWrap™, although other weatherproofing sheets known in the art may also be used. The weatherproofing sheets 51a, 51b are arranged relative to each other with weatherproofing sheet 51a overlapping weatherproofing sheet 51b to prevent moisture from passing into the home in the event moisture flows down over sheets 51a, 51b.

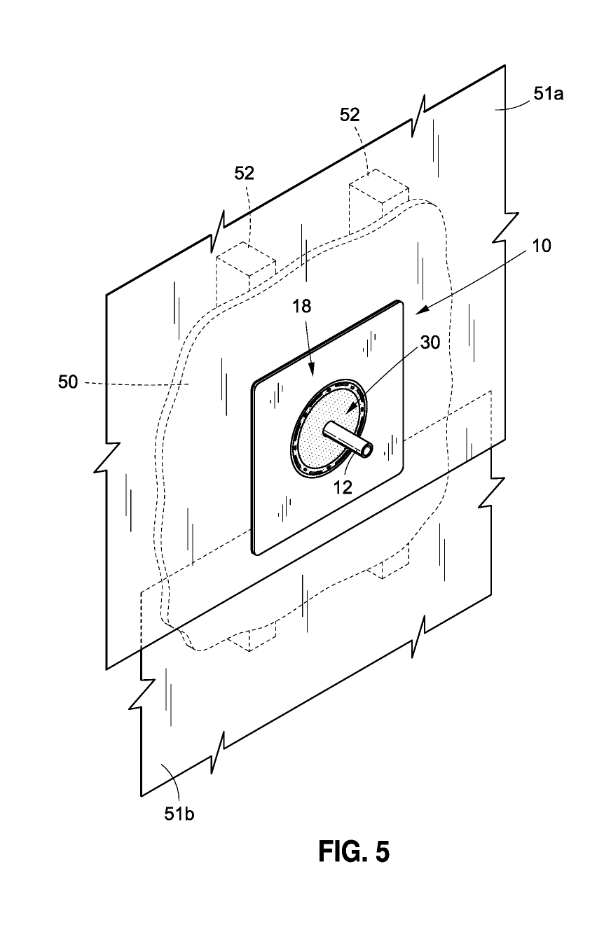

Although FIGS. 4 and 5 show a shear panel 50 disposed between the weatherproofing sheets 51a, 51b and the studs 52, it is understood that in other embodiments, the weatherproofing sheets 51a, 51b may be secured directly to the studs 52, particularly in areas that are not as susceptible to seismic activity.

The utility conduit 12 defines conduit axis 46. Before the pliable sheet 18 can be adhered to an underlying surface of the shear panel 50, the release liner 16 is removed from the pliable sheet 18 to expose the adhesive layer 14. According to one embodiment, when the release liner 16 is separated into different portions 16a, 16b, one portion 16a is initially removed to expose only a portion of the adhesive layer 14. Once the release liner portion 16a is removed, the pliable sheet 18 is positioned next to the utility conduit 12, with the first surface 20 of the pliable sheet 18 facing the weatherproofing sheets 51a, 51b, and the second surface 22 of the pliable sheet 18 facing away from the weatherproofing sheets 51a, 51b.

The pliable sheet 18 and resilient seal element 30 are then advanced over the utility conduit 12, such that the utility conduit 12 passes through the first opening 24 of the pliable sheet 18, as well as the second opening 36 of the resilient seal element 30. Passage of the utility conduit 12 through the second opening 36 causes the resilient seal element 30 to circumferentially engage the outer surface of the utility conduit 12, thereby forming a fluid-tight seal therebetween. The pliable sheet 18 is moved toward the weatherproofing sheets 51a, 51b, with the exposed portion of the adhesive layer 14 being pressed against the weatherproofing sheet(s) 51a, 51b to adhere the pliable sheet 18 to the weatherproofing sheet(s) 51a, 51b.

Once the initially exposed portion of the adhesive layer 14 is adhered to the weatherproofing sheet(s) 51a, 51b, the remaining portion 16b of the release liner 16 may be removed from the base layer 18 to expose the remaining portion of the adhesive layer 14, which can then be adhered to the weatherproofing sheet(s) 51a, 51b. By separating the release liner 16 into separate portions 16a, 16b, the user may expose only a portion of the adhesive layer 14, which allows the user to more easily adhere the base layer 18 to the weatherproofing sheet(s) 51a, 51b. In other words, by providing a smaller exposed portion of the adhesive layer 14 when initially adhering the base layer 18 to the weatherproofing sheet(s) 51a, 51b, the formation of unwanted folds or creases within the base layer 18 may be mitigated.

Once the pliable sheet 18 is adhered to the weatherproofing sheet(s) 51a, 51b, an external covering may be positioned over the pliable sheet 18, resilient seal element 30, and weatherproofing sheet(s) 51a, 51b. The external covering may be stucco, brick, siding, or any other external covering element known in the art. The utility conduit 12 extends through an opening in the external cover to allow for access to the conduit 12 outside the building.

The flashing sheet 10 allows for easy weatherproofing around a utility conduit 12 passing through an external wall of a building. The “peel-and-stick” qualities of the flashing sheet 10 enables a user to quickly and effortlessly install the flashing sheet 10.

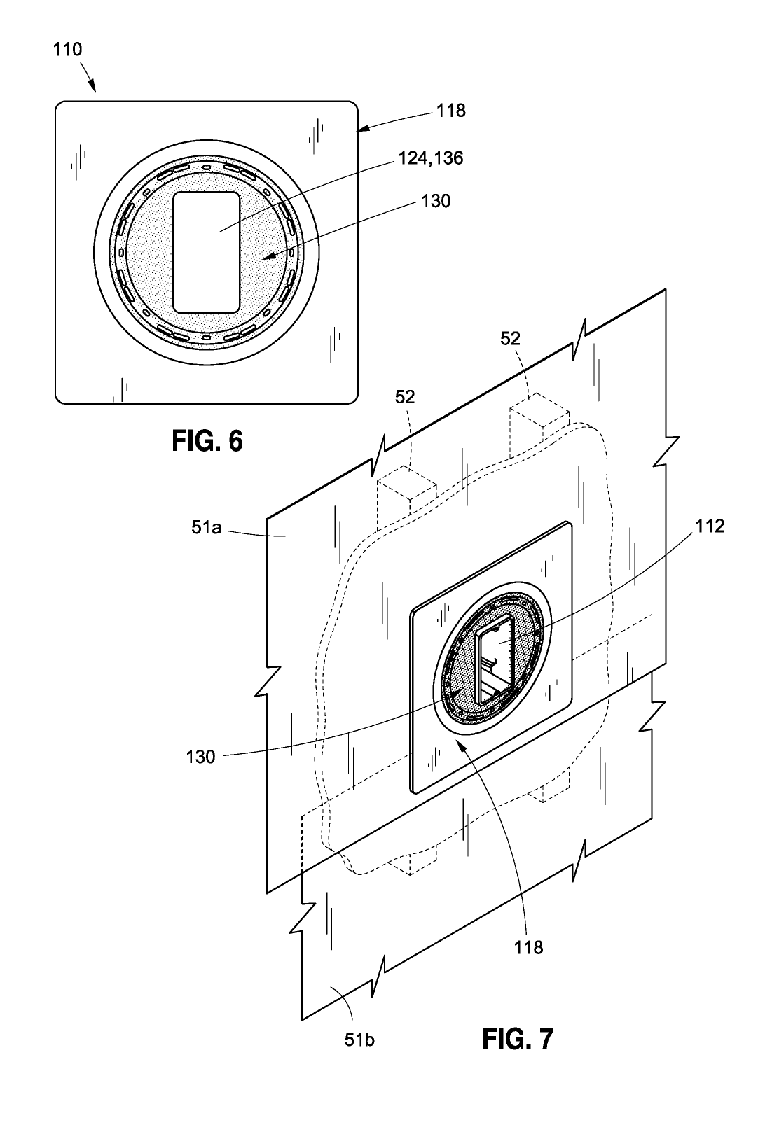

Referring now to FIGS. 6 and 7, there is depicted another embodiment of a flashing sheet 110 specifically configured and adapted to for use with an electrical junction box 112. In this regard, the primary distinction between the flashing sheet 10 of FIGS. 1-5 and the flashing sheet 110 of FIGS. 6 and 7 being the shape of the opening formed in the resilient seal element. Therefore, the following discussion of the flashing sheet 110 shown in FIGS. 6 and 7 will focus on such distinctions, while the reader is invited to refer to the previous discussion of the flashing sheet 10 for a more detailed discussion of common features.

The electrical junction box 112 includes a boarder having a defined contour. As will be described in more detail below, the flashing panel 110 is formed with a resilient seal element 130 that conforms to the contour of the electrical junction box 112 to form a fluid tight seal therebetween. The seal is formed through the interaction between the resilient, flexible seal element 130 of the flashing panel 110 and the outer surface of the electrical junction box 112.

The flashing sheet 110 generally includes a pliable sheet 118, a release liner, and a resilient seal element 130 connected to the pliable sheet 118. The release liner is selectively removeable from the pliable sheet 118 to expose an adhesive layer. The resilient seal element 130 is coupled to the pliable sheet 118 in a manner such that a portion of the resilient seal element 130 extends radially inward from the pliable sheet 118 into a sheet opening 124. The resilient seal element 130 includes a first surface, an opposing second surface, and a seal element opening 136 having a defined contour complimentary to the defined contour of the boarder of the electrical junction box 112. In the exemplary embodiment, the defined contour of the seal element opening 136 is quadrangular, and is dimensioned similarly to that of the outer contour of the electrical junction box 112. According to one embodiment, the dimensions of the seal element opening 136 are approximately equal to 4.875 inches by 2.750 inches, although the seal element opening 136 may define other sizes without departing from the spirit and scope of the present disclosure. When the electrical junction box 112 is advanced through the seal element opening 136, the size of the seal element opening 136 causes the resilient seal element 130 to engage the outer surface of the electrical junction box 112, thereby deforming the resilient seal element 130 and placing the resilient seal element 130 in tension. Furthermore, a circumferentially compressive force is exerted on the outer surface of the electrical junction box 112 by the resilient seal element 130 to form the fluid-tight seal therebetween.

In the exemplary embodiment, the resilient seal element 130 includes an annular attachment element 138 to facilitate connection between the resilient seal element 130 and the pliable sheet 118. The resilient seal element 130 may be connected to the pliable sheet 118 via an adhesive, ultrasonic welding, molding, or through the use of other fastening means or techniques known by those skilled in the art.

According to one embodiment, the flashing sheet 110 is formed independent of a flange or other structure which protrudes perpendicularly relative to the plane defined by the pliable sheet 118, which is commonly found on flashing products intended for use with electrical junction boxes 112. Along these lines, the flashing sheet 110 may be easier to manufacture and store, since the flashing sheet 110 is essentially planar, particularly when compared to those flashing panels having a flange projecting from the panel body. Furthermore, flashing panels having projecting flanges are typically designed for use with an electrical box having specific dimensions. The elastomeric qualities of the resilient seal element 130 of the flashing sheet 110 allows the resilient seal element 130 to adapt to minor variations in dimension in electrical junction boxes.

Use of the flashing sheet 110 is similar to the use of the flashing sheet 10 discussed above, with the primary difference being advancement of the flashing sheet 110 over the electrical box 112.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A flashing sheet comprising:
a pliable sheet having a first surface, an opposing second surface, and a first opening extending through the pliable sheet between the first surface and the second surface; and
a resilient seal element having a first surface, an opposing second surface, and a second opening extending through the resilient seal element between the first surface and the second surface;
the resilient seal element being coupled to the pliable sheet such that the second opening is aligned with the first opening, and at least a portion of the resilient seal element extends radially inward to extend over the first opening.

2. The flashing sheet recited in claim 1, wherein the pliable sheet is fluid impermeable.

3. The flashing sheet recited in claim 1, wherein the pliable sheet is a membrane sheet.

4. The flashing sheet recited in claim 3, wherein the pliable sheet is formed from an elastomeric material.

5. The flashing sheet recited in claim 3, wherein the pliable sheet is formed from polyethylene.

6. The flashing sheet recited in claim 3, wherein the pliable sheet is formed from flexible polyvinyl chloride.

7. The flashing sheet recited in claim 1, wherein the pliable sheet includes a base layer having an adhesive coating, the flashing sheet further comprising a release liner extending over the adhesive coating to cover the adhesive coating, the release liner being selectively removeable from the adhesive coating to expose the adhesive coating.

8. The flashing sheet recited in claim 7, wherein the release liner includes a first portion and a second portion separate from the first portion.

9. The flashing sheet recited in claim 1, wherein the pliable sheet lacks internal stiffness to counteract gravitational force.

10. The flashing sheet recited in claim 1, wherein the resilient seal element is adhered to the pliable sheet.

11. The flashing sheet recited in claim 1, wherein the resilient seal element is formed from a polymer material.

12. The flashing sheet recited in claim 1, wherein the second opening is circular.

13. The flashing sheet recited in claim 1, wherein the second opening is quadrangular.

14. The flashing sheet recited in claim 13, wherein the second opening is approximately 4.875 inches by 2.750 inches.

15. A flashing sheet comprising:
a sheet having a first surface, an opposing second surface, and a first opening extending through the sheet between the first surface and the second surface, the sheet including:
a base layer having an adhesive coating; and
a release liner extending over the adhesive coating to cover the adhesive coating, the release liner being selectively removeable from the adhesive coating to expose the adhesive coating; and
a resilient seal element having a first surface, an opposing second surface, and a second opening extending through the resilient seal element between the first surface and the second surface;
the resilient seal element being coupled to the sheet such that the second opening is aligned with the first opening, and at least a portion of the resilient seal element extends radially inward to extend over the first opening.

16. The flashing sheet recited in claim 15, wherein the sheet is a pliable sheet.

17. The flashing sheet recited in claim 16, wherein the pliable sheet lacks internal stiffness to counteract gravitational force.

18. The flashing sheet recited in claim 15, wherein the second opening is circular.

19. The flashing sheet recited in claim 15, wherein the second opening is quadrangular.

20. The flashing sheet recited in claim 15, wherein the second opening is approximately 4.875 inches by 2.750 inches.
